(19) United States
(12) Patent Application Publication
(10) Pub. No.: US 2006/0266757 A1
(43) Pub. Date: Nov. 30, 2006

(54) Reinforced silicone elastomer cookware

(76) Inventors: Enrique Camacho, Fitchburg, WI (US); Timthy A. Osswald, Madison, WI (US)

Correspondence Address: Michael Best & Friedrich LLP;Suite 3300, 100 East Wisconsin Avenue, Milwaukee, WI, 53202-4108, US

(21) Appl. No.: 11/248,595

(22) Filed: Oct. 12, 2005

Related U.S. Application Data
(60) Provisional application No. 60/685,395, filed on May 31, 2005.

(51) Int. Cl. A47J 37/00

(52) U.S. Cl. 220/912

(57) ABSTRACT

In some embodiments, cookware made of flexible silicone elastomer with a substantially rigid support frame is provided. The frame can include one or more handles, and can be fully or partially surrounded a body of the flexible silicone elastomer. In some embodiments, the frame is removable from the body. Also, in some embodiments, a substantially rigid frame is interposed between multiple body portions that can be coupled together and/or to the frame to form a unified piece of reinforced silicone cookware.

### CROSS-REFERENCE TO RELATED APPLICATIONS

Priority is hereby claimed to U.S. provisional patent application No. 60/685,395 filed on May 31, 2005, the entire contents of which are incorporated herein by reference.

### BACKGROUND

Silicone elastomers have been developed for use in a wide variety of applications and products, including without limitation gaskets, shaft seals, electrical insulators, water repellent films, and the like. Many silicone elastomers have substantially consistent properties, including relatively high strength and resiliency, over a wide temperature range (e.g., −50 to 300 degrees C.). Many silicone elastomers are also capable of successfully meeting the United States Food and Drug Administration regulations for repeated use food contact products. As such, silicone elastomers have been introduced as an alternative material for the construction of cookware.

### SUMMARY

In some embodiments, cookware for holding food product is provided, and comprises a body comprising flexible silicone elastomer, the body shaped to define at least one receptacle adapted to hold food product, wherein at least a portion of the body is deformable at least partially due to flexibility of the silicone elastomer, and a frame coupled to the body, the frame having at least one aperture into which is received a portion of the silicone elastomer.

Some embodiments of the present invention provide cookware for holding food product, wherein the cookware comprises a body comprising flexible silicone elastomer, the body shaped to define at least one receptacle adapted to hold food product, wherein at least a portion of the body is deformable at least partially due to flexibility of the silicone elastomer, and a frame coupled to the body by a bond between a surface of the frame and the flexible silicone elastomer.

In some embodiments, a method of manufacturing cookware is provided, and comprises providing a substantially rigid frame, bonding liquid silicone elastomer material to the frame, forming a body of flexible silicone elastomer having at least one receptacle shaped and dimensioned to removably receive food product, and coupling the body to the frame by bonding the liquid silicone elastomer to the frame.

Further aspects of the present invention, together with the organization and operation thereof, will become apparent from the following detailed description of the invention when taken in conjunction with the accompanying drawings.

### BRIEF DESCRIPTION OF THE DRAWINGS

The present invention is further described with reference to the accompanying drawings, which show various embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

FIG. 1 is a perspective view of reinforced silicone elastomer cookware according to an embodiment of the present invention, shown with a lid adapted to cover the reinforced silicone elastomer cookware.

FIG. 2 is a perspective view of the frame of the reinforced silicone elastomer cookware illustrated in FIG. 1.

FIG. 3A is a side view of reinforced silicone elastomer cookware according to another embodiment of the present invention.

FIG. 3B is an end view of the reinforced silicone elastomer cookware illustrated in FIG. 3A.

FIG. 4 is an exploded perspective view of reinforced silicone elastomer cookware according to another embodiment of the present invention.

FIG. 5 is a sectioned detail view of the reinforced silicone elastomer cookware illustrated in FIG. 4.

FIG. 6 is an exploded perspective view of reinforced silicone elastomer cookware according to another embodiment of the present invention.

FIG. 7 is an exploded view of reinforced silicone elastomer cookware according to another embodiment of the present invention.

FIG. 8 is an exploded perspective view of reinforced silicone elastomer cookware according to another embodiment of the present invention.

FIG. 9 is a top view of the frame and body of the reinforced silicone elastomer cookware illustrated in FIG. 8.

FIGS. 10 and 11 are perspective detail cutaway views of the reinforced silicone elastomer cookware illustrated in FIGS. 8 and 9.

FIG. 12 is a perspective detail view of the body of the reinforced silicone elastomer cookware illustrated in FIGS. 8-11.

FIG. 13 is another perspective detail cutaway view of the reinforced silicone elastomer cookware illustrated in FIGS. 8-12.

FIG. 14 is detail view of the frame of the reinforced silicone elastomer cookware illustrated in FIGS. 8-13.

FIG. 15 is detail view of the body of the reinforced silicone elastomer cookware illustrated in FIGS. 8-14.

FIGS. 16-22 are perspective sectioned views of reinforced silicone elastomer cookware according to additional embodiments of the present invention.

### DETAILED DESCRIPTION

Silicone elastomer material can provide a relatively high level of ease in removing food product from a piece of cookware. For example, in addition to the inherent surface properties of silicone elastomer material, the capability of silicone elastomer material to bend and flex can assist in the release of food from cupcake cookware, cake pans, and other types of cookware. In addition, silicone elastomers do not conduct heat like metals do, allowing a user to touch the silicone cookware shortly after removing it from a heated oven or other heating environment. While silicone elastomers have advantages in bakeware products, the present invention is not limited to bakeware products. Cookware according to the various embodiments of the present invention can be manufactured for radiant and/or convection oven, microwave, refrigerator, and freezer products. Therefore, as used herein, the term “cookware” encompasses products adapted to hold any food product before, during, and/or after cooking of any type, and products adapted for storage of food in refrigerator, freezer, room temperature, or other environments. Accordingly, all references to a particular type of cookware or food storage product herein (e.g., a muffin pan, cake pan, and the like) are exemplary, and should not be considered as limiting.

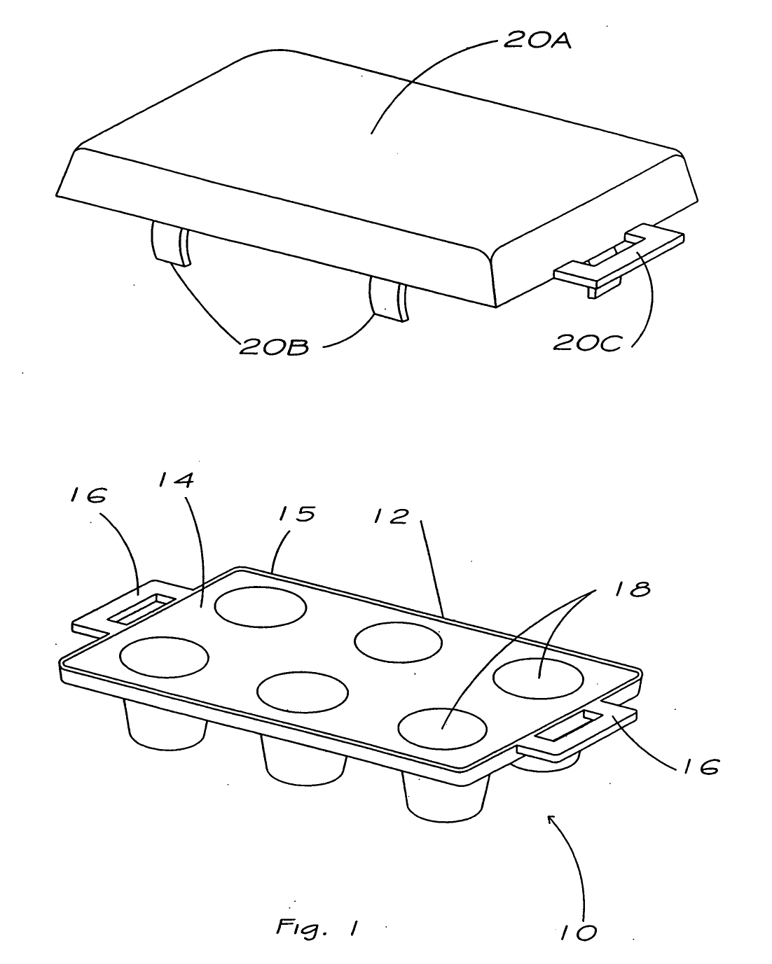

FIG. 1 illustrates cookware according to an embodiment of the present invention. The cookware illustrated in FIG. 1 is a muffin pan 10 by way of example only. The pan 10 includes a substantially rigid frame 12 and a flexible body 14. The body 14 of the pan 10 comprises silicone elastomer material, and in some embodiments includes silicone elastomer cross-linked with platinum. The body 14 in the illustrated embodiment includes six individual receptacles 18. In other embodiments, the body 14 of the pan 10 includes a single receptacle, or any other number of receptacles having the same or different shapes.

In some embodiments, both the frame 12 and the body 14 are made of FDA compliant materials. The body 14 can comprise silicone elastomer, and can be manufactured to have any degree of firmness desired. For example, in some embodiments, the body 14 is sufficiently flexible to enable a user to partially or fully invert on or more of the receptacles 18, to bow a side or bottom wall of one or more receptacles 18, or to otherwise deform at least part of one or more receptacles 18 in order to enable removal of food product therefrom. In other embodiments, the body 14 is less flexible, thereby enabling less deformability by a user. For example, the body 14 can be sufficiently stiff to resist or prevent inversion of the receptacles 18, but to still permit a user to bow a side or bottom wall of one or more receptacles 18. Less deformable bodies 14 can provide a desirable balance between a body 14 that is incapable of retaining its shape under moderate pressure (e.g., during use, movement, and the like) and a body 14 that is incapable of sufficient flexure to assist in the release of food product from the receptacles 18.

The flexibility of the body 14 can be selected in a number of different manners. In some embodiments, the flexibility of the body 14 is selected by selecting the thickness of the body 14, in which cases one or more areas of the body 14 can be made thicker or thinner to decrease or increase the flexibility of the body 14 in such areas, respectively. For example, the side and/or bottom walls of the receptacles 18 in the illustrated embodiment can be made relatively thin to enable increased flexure of the receptacles 18, or relatively thick to reduce such flexibility. As another example, the portions of the body 14 other than the receptacles 18 can be made relatively thick to provide increased rigidity to the body 14, or relatively thin for reduced rigidity. Also, the body 14 can have varying thicknesses in different areas of the body 14, such as by having thinner walls of the receptacles 18 and thicker walls in other areas of the body 14, thinner side walls of the receptacles 18 and thicker bottom walls of the body 14 (and vice versa), and the like. Still other combinations of body thicknesses in different areas of the body 14 are possible, and fall within the spirit and scope of the present invention.

In some embodiments, the flexibility of the body 14 is selected by changing the stiffness of the silicone elastomer material in different areas of the body 14. For example, those portions of the body 14 defining the side and/or bottom walls of the receptacles 18 can comprise silicone elastomer material that is more or less flexible than the silicone elastomer material in the portions of the body 14, thereby providing receptacles 18 that are more or less flexible than the surrounding areas of the body 14, respectively. As another example, the side walls of the receptacles 18 can comprise silicone elastomer material having less or greater stiffness than that of the bottom walls of the receptacles 18. Still other combinations of silicone elastomer stiffness in different areas of the body 14 are possible, and fall within the spirit and scope of the present invention.

Body flexibility can also or instead be selected by features of the body 14 shaped, dimensioned, and positioned to increase or decrease the deformability of the body 14 in one or more areas. For example, the receptacles 18 and/or any of the remaining areas of the body 14 can be provided with ribs, bumps, lips or other protrusions (not shown) to decrease the flexibility of the body 14 in such areas, can be provided with grooves, dimples, or other blind or through apertures (also not shown) to increase the flexibility of the body 14 in such areas, or can be provided with any combination of such protrusions or apertures as desired. These features of the body 14 can be located to increase or decrease the flexibility of the entire body 14, or to increase or decrease the flexibility of one or more portions of the body 14 with respect to one or more other portions of the body 14 as described above in connection with the thickness and stiffness properties of the body 14.

It should also be noted that the various ways of selecting the flexibility of the body 14 as described herein are not exclusive of one another. Any combination of such manners can be employed to result in desired flexibility in different areas of the body 14, such as a combination of thicker and thinner portions of the body 14 and ribs or grooves in desired locations of the body 14, a combination of thicker and thinner portions of the body 14 and varying elastomer stiffness in different portions of the body 14, and the like.

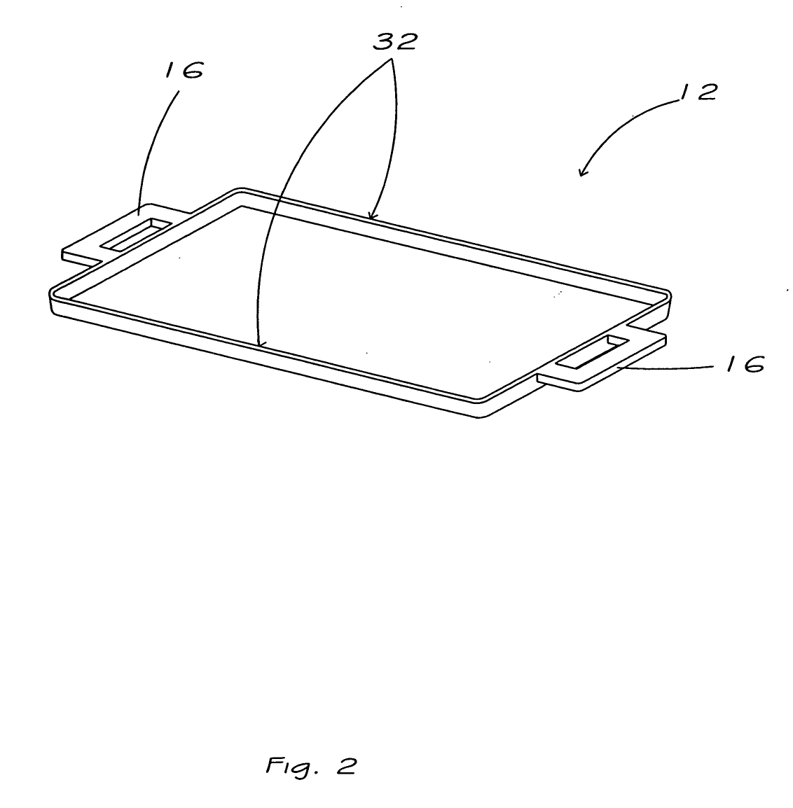

With reference again to the illustrated embodiment of FIGS. 1 and 2, the frame 12 can provide a degree of structural integrity to the pan 10. In those embodiments in which the body 14 comprises flexible silicone elastomer material that is sufficiently flexible to deform under relatively low or moderate loading or pressure, the frame 12 can prevent the body 14 (and therefore the pan 10) from folding or collapsing during handling. In any case, the frame 12 can increase the rigidity of the pan 10. In this manner, the likelihood of product spillage or tipping from the pan 10 can be reduced in some cases. Additionally, the frame and body construction of the illustrated pan 10 can provide greater control over the pan 10 when being moved, such as when being transferring the pan 10 into or out of an oven.

The frame 12 illustrated in FIG. 1 is shown by itself in FIG. 2, and is generally rectangular, with elongated sides 32. The frame 12 can have any other shape desired, and in some embodiments can have a shape corresponding generally to the overall shape of the body 14. For example, the frame 12 can be generally circular or elliptical, can have a square or other polygonal shape, can have an irregular shape, or can have any other shape conceivable for cookware. Also, the frame 12 can have any cross-sectional shape, such as a substantially rectangular, triangular, or other polygonal shape, a round, elliptical, or other rotund shape, an irregular shape, or any other cross sectional shape desired.

The frame 12 in the illustrated embodiment of FIG. 1 has a shape providing increased rigidity to the body 14, which can otherwise be flexible as described above. The frame 12 can be constructed of any substantially rigid material having sufficient strength and durability for household use, and in some embodiments being capable of withstanding cooking temperatures of an oven without significant change in mechanical properties. For example, the frame 12 can be made of steel, stainless steel, aluminum, brass, iron, titanium, or other substantially rigid metal, a substantially rigid polymer, a ceramic or other refractory material, a composite material, fiberglass, and the like, and any combination thereof in coated or uncoated form. The frame 12 can be made of an FDA compliant material, and in some embodiments is selected for a good adhesion strength to silicone elastomer. By way of example only, in some embodiments, the frame 12 includes a high-temperature plastic to which the silicone elastomer of the body 14 will adhere.

In the illustrated embodiment of FIG. 1, the frame 12 is coupled to the body 14 at an upper edge 15 of the pan 10. In other embodiments, the frame 12 is coupled to the body 14 at other locations, such as at a lower portion of the pan 10 or at one or more locations intermediate the upper edge 15 and bottom of the pan 10.

The frame 12 illustrated in FIGS. 1 and 2 is a single integral member formed in any suitable manner. In other embodiments, the frame 12 is constructed on two or more elements coupled together in any manner, such as by welding, brazing, adhesive or cohesive bonding material, screws, bolts, rivets, or other conventional fasteners, inter-engaging elements, and the like (in some cases depending at least in part upon the type of material used for the frame 12).

With continued reference to the illustrated embodiment of FIGS. 1 and 2, the frame 12 can be substantially rectangular or can have any of the other shapes described above. It should be noted that the frame 12 need not necessarily substantially lie in plane as shown in FIG. 2. In some embodiments, the frame 12 has other shapes, such as frames 12 extending along the sides of one or more of the receptacles 18 or other portions of the pan 10, frames 12 extending below any portion of the pan 10, and the like. For example, the frame 12 illustrated in FIG. 2 can have one or more legs or other portions extending below the upper edge 15 of the pan 10 (e.g., for supporting the pan 10 upon a surface, for preventing inadvertent deformation of the body 14 during transport or use of the pan 10, and the like), can have portions extending about and/or beneath one of more of the receptacles 18, and the like.

In some embodiments, the frame 12 includes one or more handles 16 for enabling a user to grasp the pan 10. In the illustrated embodiment of FIGS. 1 and 2, for example, the frame 12 includes a pair of handles 16—one on each end of the frame 12. The handles can be integral with the rest of the frame 12 or can be coupled thereto in any of the manners described above with reference to multiple-piece frame construction. In some embodiments, the handles 16 are exposed (i.e., not covered by the silicone elastomer of the body 14). In other embodiments, the silicone elastomer of the body 14 partly or entirely surrounds the handles 16, such as around the periphery of the handles 16, on one of the upper and lower surfaces of the handles 16, and the like.

The body 14 of the pan 10 can be coupled to the frame 12 in a number of different manners. In some embodiments, the body 14 of the pan 10 is coupled to the frame 12 by bonding the body 14 to the frame 12 in a molding or casting process. The resulting connection can be substantially entirely mechanical, wherein the frame 12 is trapped within the body 14. Other types of mechanical connections are described below. In other embodiments, the resulting connection can be defined by a bond between the silicone elastomer and the surface of the frame 12. The connection can be enhanced in some cases by a chemical bond between the silicone elastomer and the material of the frame 12. Also or instead, the connection can be provided by an adhesive or cohesive bonding material, such as glue, epoxy, and the like.

As mentioned above, the connection between the frame 12 and the silicone elastomer material of the body 14 can be mechanical in nature. Such mechanical connections can be employed in connection with the other types of silicone elastomer-to-frame connections described herein, if desired, and in some cases can be releasable or permanent as desired. Mechanical connections include connections in which the frame 12 is trapped within the silicone elastomer material of the body 14 in one or more manners. For example, the frame 12 illustrated in the embodiment of FIGS. 1 and 2 is overmolded with silicone elastomer material trapping the frame 12 within the body 14 (and in some embodiments, also creating a chemical bond between the frame 12 and the body 14 as described above). The frame 12 in the illustrated embodiment of FIGS. 1 and 2 is at least partially overmolded with FDA-compliant silicone elastomer to provide an integrated assembly in the form of a hygienic and easy-to-clean pan 10. In some embodiments, the pan 10 has no gaps where food residue can collect during the life of the product. The overmolding process can be performed in any suitable manner, such as by casting liquid silicone elastomer, injection molding or spin casting liquid silicone, and the like. For example, the pan 10 can be formed by injection molding liquid silicone through cold runners and gates located to optimize the properties of the pan 10 (e.g., thickness, stiffness, and the like).

Other types of mechanical connections can be utilized to connect the body 14 of the pan 10 to the frame 14. For example, one or more portions of the frame 12 can be permanently or releasably received within grooves, recesses, or other blind or through apertures in the body 14. Such a connection can be made during molding of the pan 10 or afterwards, and can include one or more snap-fit connections, pin and aperture connections, tongue and groove connections, any other inter-engaging element connections, and the like). Alternatively or in addition, one or more portions of the body 14 can be permanently or releasably received within grooves, recesses, or other blind or through apertures in the frame 12, including any of the types of connections described above. Any mechanical connection described and illustrated herein can be supplemented with other types of connections, including a chemical bond between the body 14 and the frame 12 and/or other manners of connection described herein.

In some embodiments, the pan 10 is provided with a removable cover 20A for protecting contents of the pan 10. The cover 20A can include clips 20B or other fasteners for attachment to the frame 12, handles 20C, or other portion of the pan 10. Whether used alone or in combination with handles 16 on the frame 12, the handles 20C of the cover 20A can enable a user to grasp and move the pan 10.

As mentioned above, the pan 10 illustrated in FIG. 1 is only an example of the type of cookware that can be produced with the frame and body construction described above. Examples of other cookware having the frame and body construction include, without limitation, other pans, such as meatloaf pans, cake pans, bread pans, JELL-O™ molds, and the like. Likewise, cookware according to other embodiments of the present invention illustrated and described herein are presented by way of example only, and can take any other cookware forms desired.

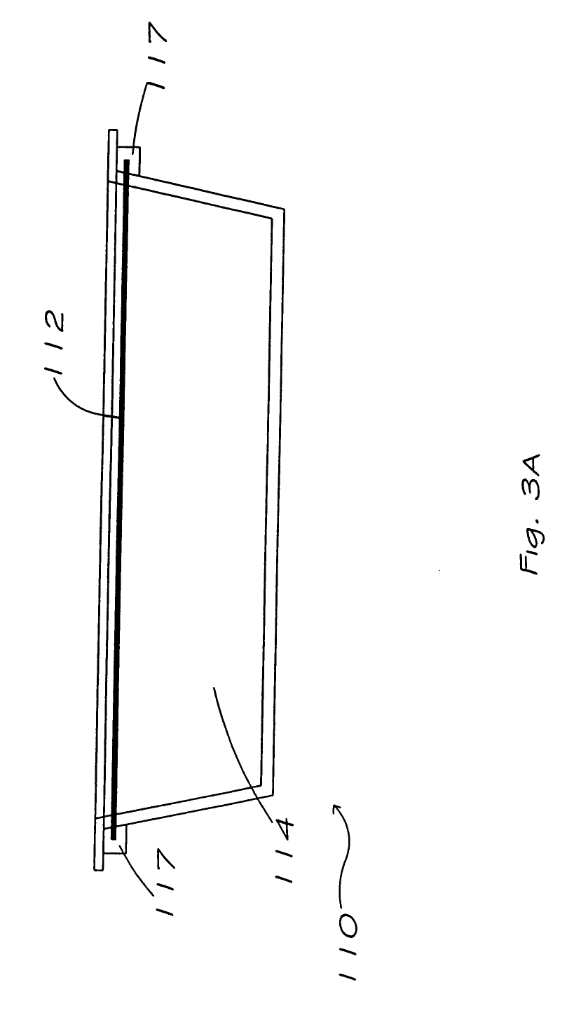

FIGS. 3A and 3B illustrate another piece of cookware according to the present invention. The elements and features of this embodiment are similar in many ways to elements and features in embodiments described above and illustrated in FIGS. 1 and 2. Accordingly, the following description focuses primarily upon those elements and features that are different from the embodiment described above. Reference should be made to the above description for additional information regarding the elements, features, and possible alternatives to the elements and features of the cookware illustrated in FIGS. 3A and 3B and described below. Elements and features of the embodiment shown in FIGS. 3A and 3B that correspond to elements and features of the embodiment of FIGS. 1 and 2 are designated hereinafter in the 100 series of reference numbers.

The piece of cookware 110 illustrated in FIGS. 3A and 3B includes a substantially rigid frame 112 that is not fully overmolded by a silicone elastomer body 114. Rather, the frame 112 is coupled to the silicone elastomer body 114 by one or more portions 117 of the body 114 through which the frame 112 extends, thereby providing support locations for the body 114. The portions 117 can have any shape, (e.g., block-shaped portions, tubular portions, tab-shaped portions, and the like), and can be defined by one or more side walls of the body 113, top or bottom portions of the body 114, and/or any other portions of the body 114. In the illustrated embodiment of FIGS. 3A and 3B, two such portions 117 are provided (one at each end of the piece of cookware 110), and are defined by projections of the silicone elastomer body at the ends of the body 114. In other embodiments, the frame 112 can extend through any number of other portions 117 in order to connect the frame 112 to the body 114. One of more of the portions 117 can also function as grasping areas (e.g., handles, lips for a user's fingers, and the like) for a user. Alternatively or in addition, the frame 112 can be used for grasping by a user, and can incorporate dedicated portions (e.g., handles, protruding portions, and the like) for this purpose. As with the other embodiments described herein, the piece of cookware 110 illustrated in FIGS. 3A and 3B can be any other type of cookware desired, and can have any other shape.

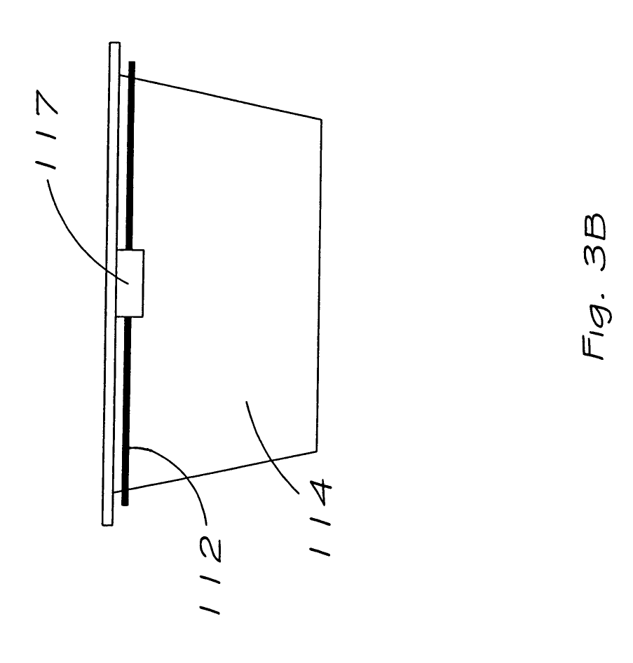

FIGS. 4A and 4B illustrate another piece of cookware according to the present invention. The elements and features of this embodiment are similar in many ways to elements and features in embodiments described above and illustrated in FIGS. 1-3B. Accordingly, the following description focuses primarily upon those elements and features that are different from the embodiments described above. Reference should be made to the above description for additional information regarding the elements, features, and possible alternatives to the elements and features of the cookware illustrated in FIGS. 4A and 4B and described below. Elements and features of the embodiment shown in FIGS. 4A and 4B that correspond to elements and features of the embodiment of FIGS. 1-3B are designated hereinafter in the 200 series of reference numbers.

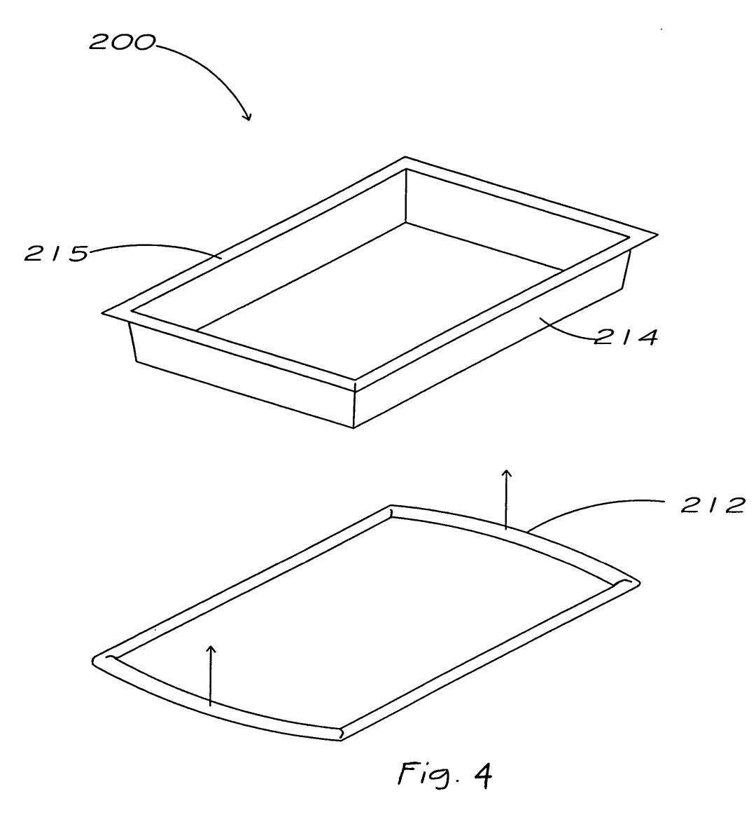

As mentioned above, the silicone elastomer body of the cookware 210 can be coupled to the frame 212 in a number of different manners, some of which are releasable, and some of which are permanent. In the illustrated embodiment of FIGS. 4 and 5, for example, the frame 212 and the body 214 are separate pieces that are shaped to engage one another at an upper edge 215 of the body 214 (although other locations of such engagement are possible, as also discussed above). The body 214 illustrated in FIGS. 4 and 5 includes a groove 219 which accepts the frame 212 or a portion thereof. The groove 219 and frame 212 can be shaped to engage in one or more snap fits as best shown in FIG. 5, which can be permanent or releasable depending at least in part upon the flexibility of the body 214 and/or the frame 212. Snap-fit engagements are only one example of the manners in which the frame 212 can be permanently or releasably mechanically coupled to the body 214, as described above. A number of other connection types can be used (e.g., pin and aperture connections, and other types of inter-engaging element connections, clips, clamps, and the like), each of which falls within the spirit and scope of the present invention. Although not shown in FIGS. 4 and 5, the frame 212 can have additional features, such as handles, legs, one or more portions framing the sides and/or underside of the body 214, and the like. It is also contemplated that the upper edge 215 of the body 214 and/or the frame 212 can be shaped to define one or more handles or other grasping locations for a user.

In some embodiments, the cookware disclosed herein can be converted for use with or without a frame, or with or without a complete frame. For example, in some embodiments, part or all of the frame can be disconnected from the body, whether for certain types of use (e.g., microwave versus conventional oven use), or for other reasons (e.g., separate storage, cleanability of both parts separately, interchangeability for frames having different shapes and sizes to be coupled to the same body, and the like). The cookware 200 illustrated in FIGS. 4 and 5 can have this convertability feature, wherein the body 214 to be used, stored, and/or cleaned with or without the frame 212, and wherein the frame 212 can be interchanged with one or more other frames having different shapes and features, such as frames having handles, frames having lid engagement elements, and the like. Similarly, this convertability feature can enable a user to use the same frame for different bodies 214, such as two or more different bodies having the same or similar connecting elements or features (e.g., grooves 219) for connection to the same frame 212.

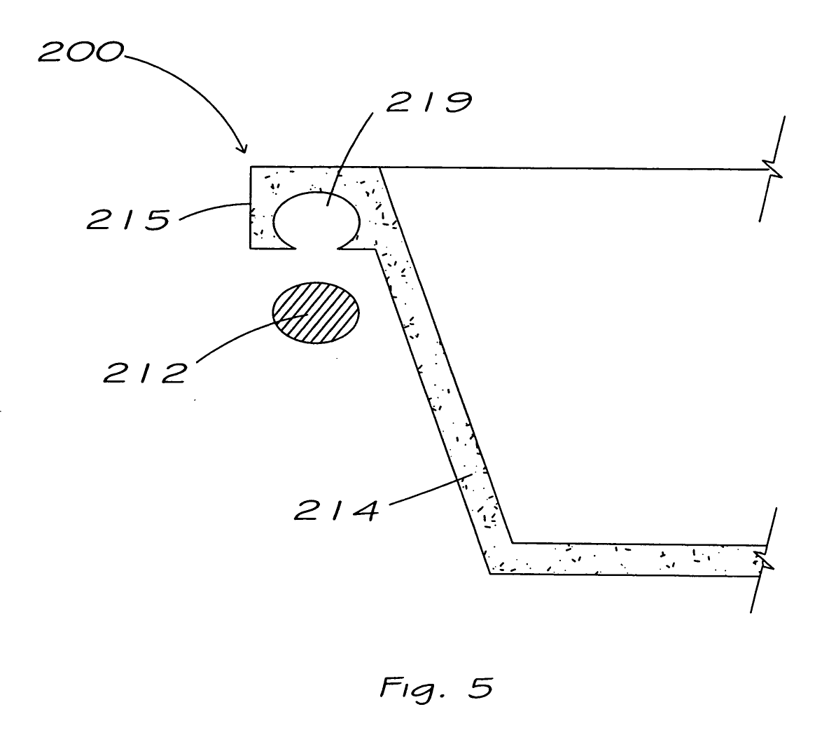

FIG. 6 illustrates another piece of cookware according to the present invention. The elements and features of this embodiment are similar in many ways to elements and features in embodiments described above and illustrated in FIGS. 1-5. Accordingly, the following description focuses primarily upon those elements and features that are different from the embodiments described above. Reference should be made to the above description for additional information regarding the elements, features, and possible alternatives to the elements and features of the cookware illustrated in FIG. 6 and described below. Elements and features of the embodiment shown in FIG. 6 that correspond to elements and features of the embodiments of FIGS. 1-5 are designated hereinafter in the 300 series of reference numbers.

The cookware 300 illustrated in FIG. 6 includes a substantially rigid frame 312 located between an inner and outer portions 314A, 314B of the silicone elastomer body 314. The frame 312 can take any of the frame shapes described above and illustrated in FIGS. 1-5, and is illustrated in FIG. 6 as being generally basket-shaped by way of example only. The inner and outer portions 314A, 314B of the body 314 can be coupled to the frame 312 and/or coupled to one another in any manner. It is contemplated that the inner and outer portions 314A, 314B can interlock or can otherwise be coupled to one another and/or to the frame 312 in virtually any manner to define a single unit of reinforced silicone cookware. In some embodiments, the inner and outer portions 314A, 314B are coupled together and/or to the frame 312 by being molded, cast, or otherwise formed together during manufacturing operations. In other embodiments, the inner and outer portions 314A, 314B are coupled together and/or to the frame 312 by adhesive or cohesive bonding material, by being chemically bonded together, by inter-engaging features or elements on the inner and outer portions 314A, 314B and/or the frame 312 (e.g., pins and apertures on the inner and outer portions 314A, 314B and/or on the frame 312, snap-fit engagement elements on the inner and outer portions 314A, 314B and/or on the frame 312, and the like), by rivets, screws, and other conventional fasteners, and the like. When the inner and outer portions 314A, 314B are coupled to one another and/or to the frame 312, the frame 312 is captured between the inner and outer portions 314A, 314B to provide an integral structure.

With continued reference to the cookware 300 illustrated in FIG. 6, the frame 312 can provide structural support to the inner and outer portions 314A, 314B of the body 314 in those embodiments in which the body 314 is relatively flexible. Also, in some embodiments, the inner and outer portions 314A, 314B encase or substantially entirely encase the frame 312 so that the body 314 is the only portion of the cookware 300 that comes into contact with food product during normal use of the cookware 300. Additionally, in some embodiments, the frame 312 can be disconnected from the inner and/or outer portions 314A, 314 (e.g., by use of any of the releasable connections described above), thereby enabling a user to more easily deform any portion of the body 314 to remove food product therefrom, to clean the cookware 300, to use the cookware without the frame 312, to replace the frame 312 with a frame having a different size or shape, and the like.

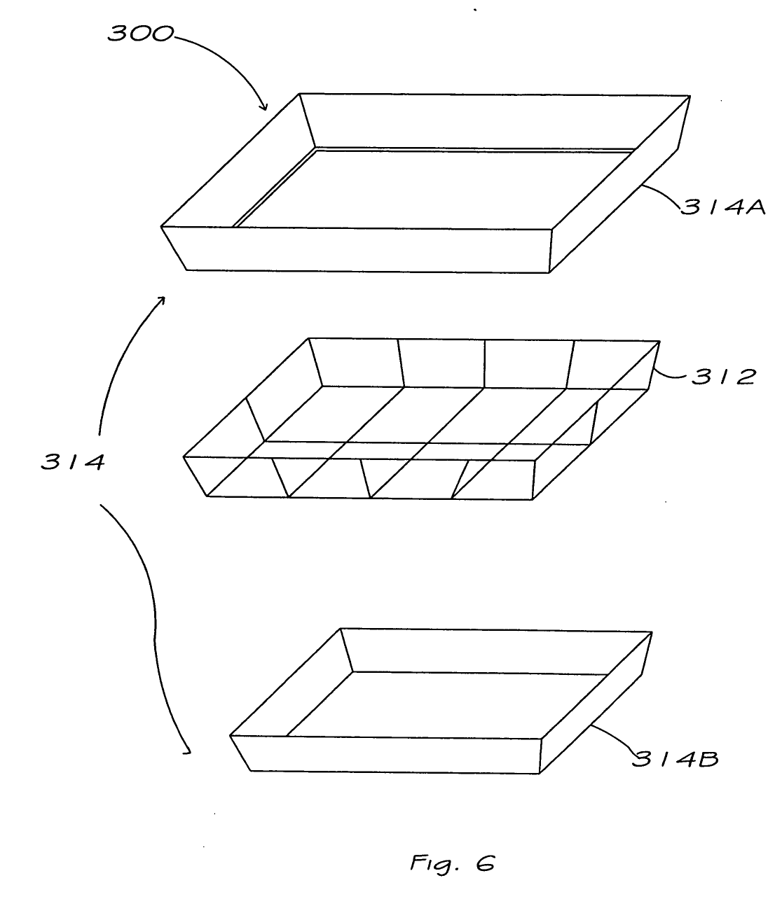

FIG. 7 illustrates another piece of cookware according to the present invention. The elements and features of this embodiment are similar in many ways to elements and features in embodiments described above and illustrated in FIGS. 1-6. Accordingly, the following description focuses primarily upon those elements and features that are different from the embodiments described above. Reference should be made to the above description for additional information regarding the elements, features, and possible alternatives to the elements and features of the cookware illustrated in FIG. 7 and described below. Elements and features of the embodiment shown in FIG. 7 that correspond to elements and features of the embodiments of FIGS. 1-6 are designated hereinafter in the 400 series of reference numbers.

In the illustrated embodiment of FIG. 7, the cookware 400 includes a frame 412 having openings 411 to accept one or more body portions 414 (only two of which are shown in FIG. 7) in any of the openings 411. The body portions 414 shown in FIG. 7 each include an outwardly extending upper edge 415 for supporting the body portion 414 upon insertion into an opening 411 in the frame 412. In other embodiments, the body portions 414 can have other features performing this function, such as tabs, pins, or other protrusions extending outwardly to contact the frame 312. The upper edge 415 can have any shape desired, and in some embodiments is shaped to correspond to one or more portions of the frame 412. For example, in the illustrated embodiment of FIG. 7, the upper edge 415 includes downwardly extending portions 415A engaging the frame 412 to prevent the body portion 414 from falling through the opening 411 when the frame 412 is lifted for transport and/or to prevent or reduce movement of the body portions 414 with respect to the frame 412. Other features and elements of the body portions 414 and/or the frame 412 can perform either or both of these functions, such as tongue and groove connections between the body portions 414 and the frame 412, pin and aperture connections between the body portions 414 and the frame 412, and the like.

In some embodiments, the frame 412 can be provided with one or more handles 416, such as the pair of handles shown in FIG. 7. As with the other embodiments of the cookware described and illustrated herein, the body portions 414 can be supported by the frame 412, and in some embodiments can be removable from the frame 412 for the same reasons described above with reference to the embodiments of FIGS. 5 and 6.

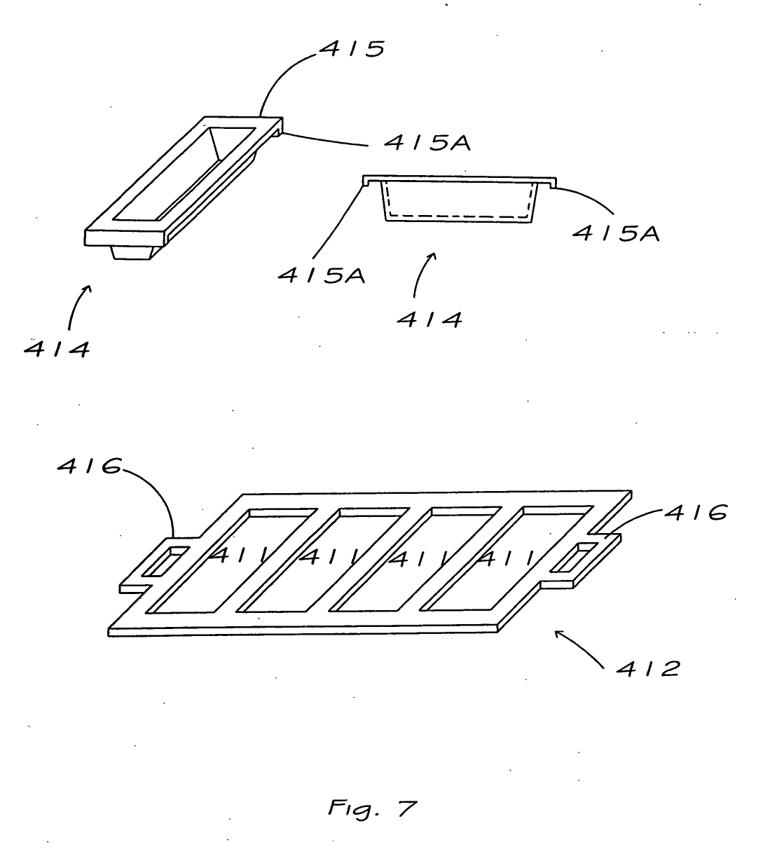

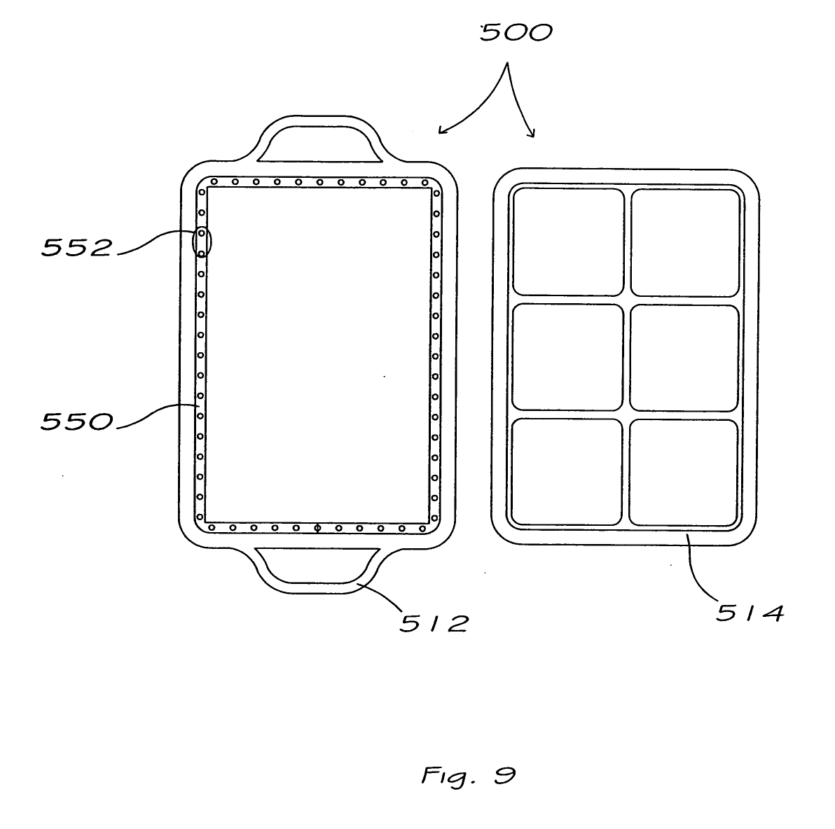

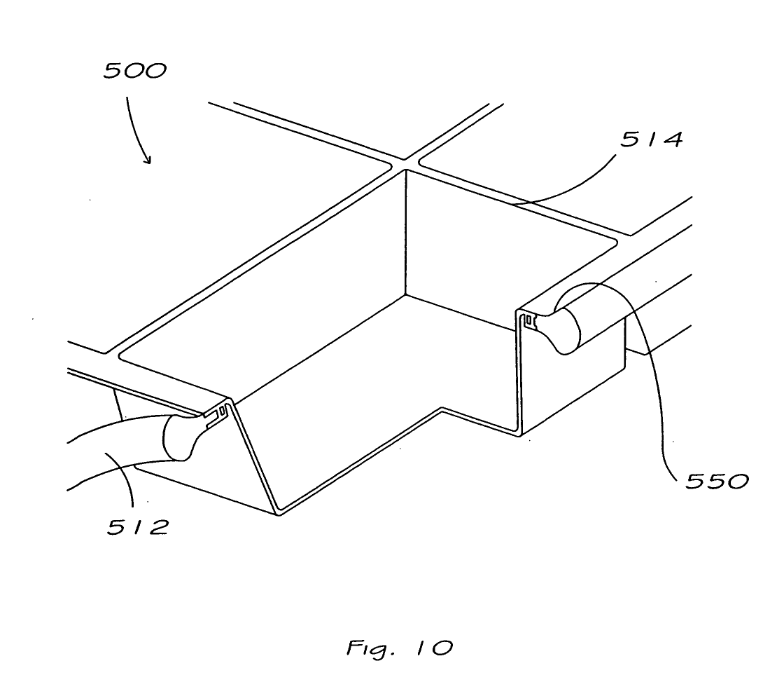

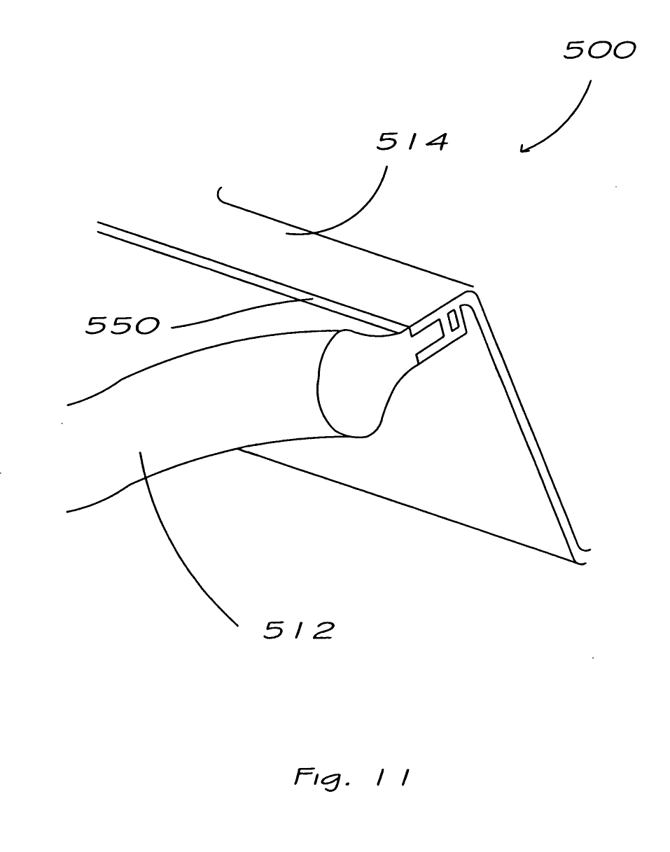

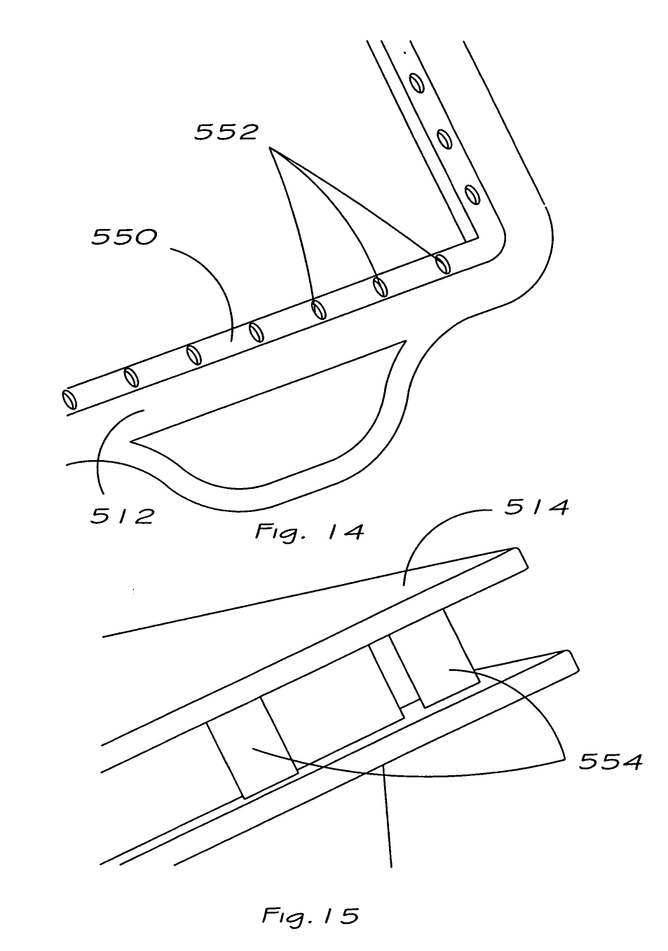

FIGS. 8-15 illustrate another piece of cookware according to the present invention. The elements and features of this embodiment are similar in many ways to elements and features in embodiments described above and illustrated in FIGS. 1-7. Accordingly, the following description focuses primarily upon those elements and features that are different from the embodiments described above. Reference should be made to the above description for additional information regarding the elements, features, and possible alternatives to the elements and features of the cookware illustrated in FIG. 8-15 and described below. Elements and features of the embodiment shown in FIGS. 8-15 that correspond to elements and features of the embodiments of FIGS. 1-7 are designated hereinafter in the 500 series of reference numbers.

The cookware 500 illustrated in FIGS. 8-15 includes a frame 512 and a flexible silicone elastomer body 514 coupled to the frame 512. As described above, some embodiments of cookware according to the present invention rely at least in part upon a mechanical connection between the frame 512 and the body 514 to secure the frame 512 to the body 514, others rely at least in part upon a chemical bond between the frame 512 and the body 514 for this purpose, and still others rely upon a mechanical connection and chemical bonding between the frame 512 and the body 514 for this purpose. Any of these types and combinations of connections can be utilized in any of the embodiments described and illustrated herein. In the illustrated embodiment of FIGS. 8-15, for example, the body 514 is connected to the frame 512 mechanically and by chemical bonding between the silicone elastomer material of the body 514 and the frame 512. In other embodiments, no chemical bonding exists between the silicone elastomer material and the frame 512 (e.g., in cases where the material of the frame 512 does not react or otherwise chemically bond to the silicone elastomer material of the body 514). In such embodiments, the mechanical connection (described below) between the body 514 and the frame 512 is relied upon to secure the body 514 to the frame 512.

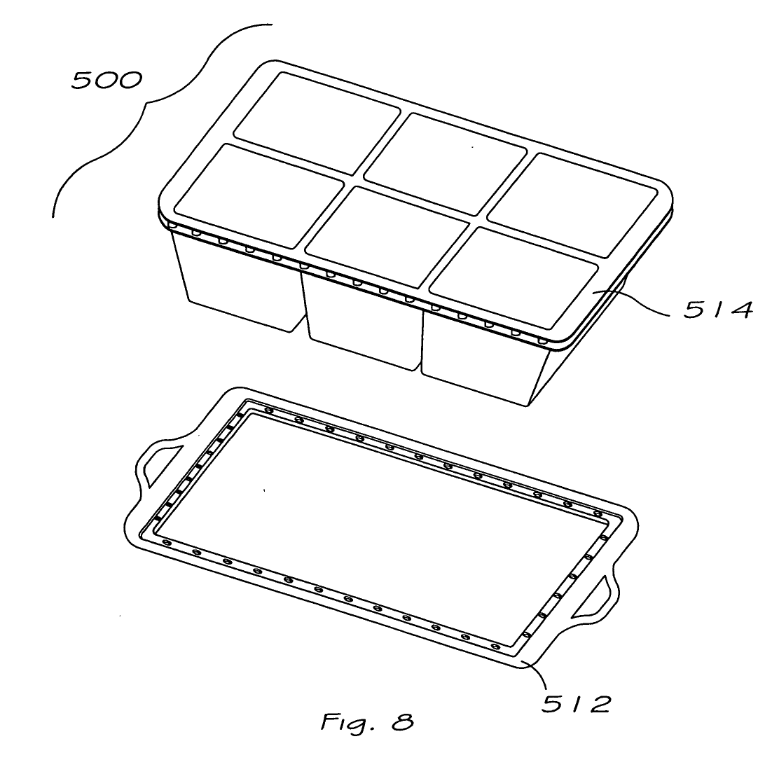

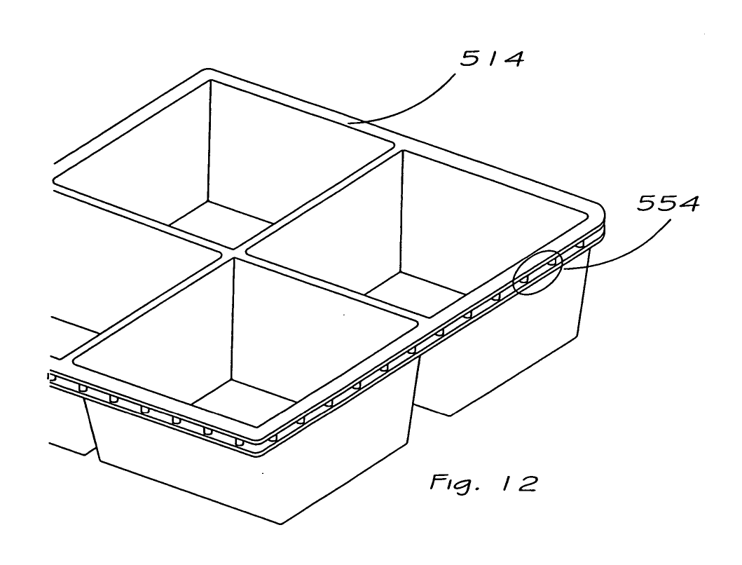

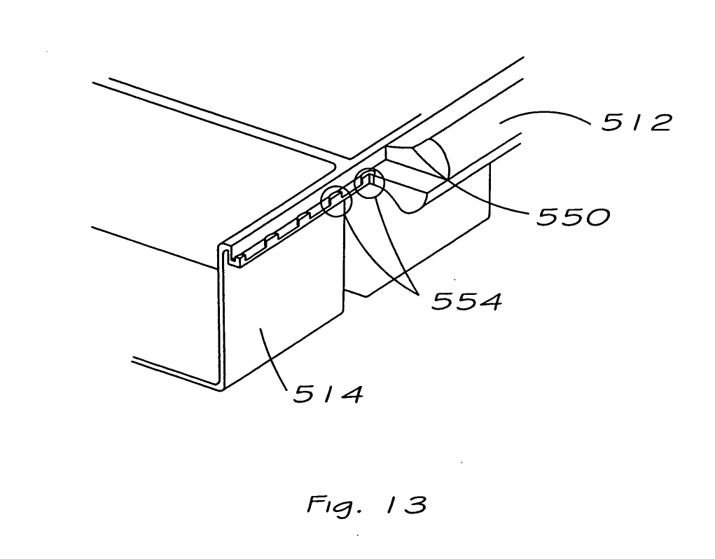

With reference to FIGS. 8 and 9, the illustrated frame 512 includes a lip 550 (see FIGS. 13 and 14) in which are defined a plurality of apertures 552 into which silicone elastomer material of the body 514 is received. The apertures 552 illustrated in FIGS. 8 and 9 extend fully through the lip 550 of the frame 512, although in other embodiments, any or all of the apertures 552 can be blind apertures. Also, the apertures 552 illustrated in FIGS. 8 and 9 are each substantially round in shape. In other embodiments, the apertures 552 can have any other shape desired. For example, the apertures 552 can be oval, substantially elongated (e.g., defined by slits, grooves, or other elongated features of the frame 512), or irregular in shape, can be rectangular, triangular, or have any other polygonal shape, and the like. Any number of apertures 552 can be utilized for receiving silicone elastomer material of the body 514 as just described, and can be located in the lip 550 and/or in any other portion of the frame 512.

As described above, silicone elastomer material of the body 514 is received within the apertures 552 of the frame 512. This relationship between the body 514 and the frame 512 can be produced in many of the manufacturing manners described earlier (such as by molding or casting the silicone elastomer material over the frame 512 and the apertures 552, or in other manners). In some embodiments, the silicone elastomer thereby forms a plurality of columns 554 extending partly or fully through the frame 512. Also in some embodiments, the columns 554 of silicone elastomer material are joined to the rest of the body 514 at both ends of the columns 554 (in embodiments in which the silicone elastomer material of the body 514 is located on both sides of the frame 512).

In the aperture and column structure of the cookware 500 described above and illustrated in FIGS. 8-15 provide a mechanical connection between the body 514 and the frame 512 in order to secure the body 514 and frame 512 together as an integrated unit. It should be noted that such a mechanical connection can be established with or without enclosing the frame 512 entirely in the silicone elastomer material of the body 514. For example, in the illustrated embodiment of FIGS. 8-15, the silicone elastomer material covers only the lip 550 of the frame 512, rather than the entire frame 512. More or all of the frame 514 can be covered by the silicone elastomer material in other embodiments.

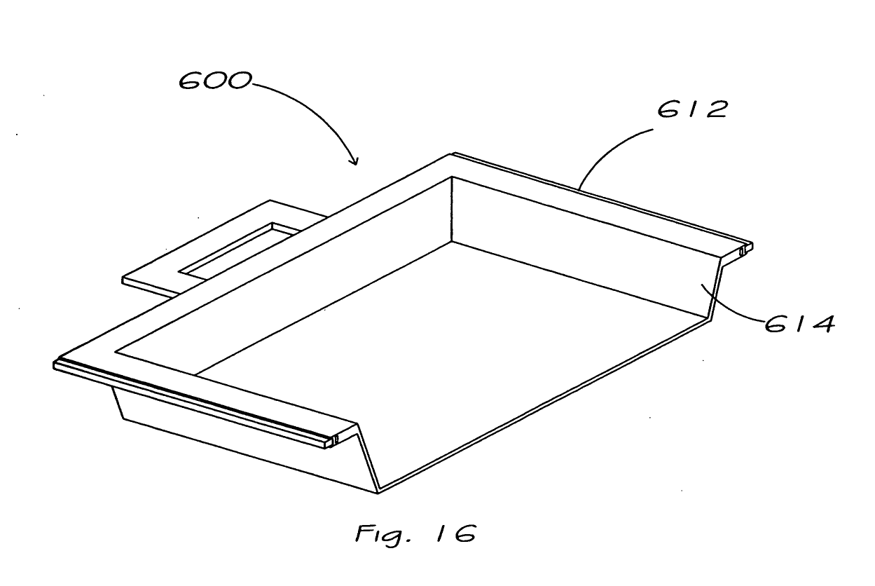

FIGS. 16-22 illustrate additional pieces of cookware according to the present invention. The elements and features of the embodiment illustrated in FIGS. 16-22 are similar in many ways to elements and features in embodiments described above and illustrated in FIGS. 1-15. Accordingly, the following description focuses primarily upon those elements and features that are different from the embodiments described above. Reference should be made to the above description for additional information regarding the elements, features, and possible alternatives to the elements and features of the cookware illustrated in FIG. 16-22 and described below. Elements and features of the embodiments shown in FIGS. 16-22 that correspond to elements and features of the embodiments of FIGS. 1-15 are designated hereinafter in the 600, 700, 800, 900, 1000, 1100, and 1200 series of reference numbers.

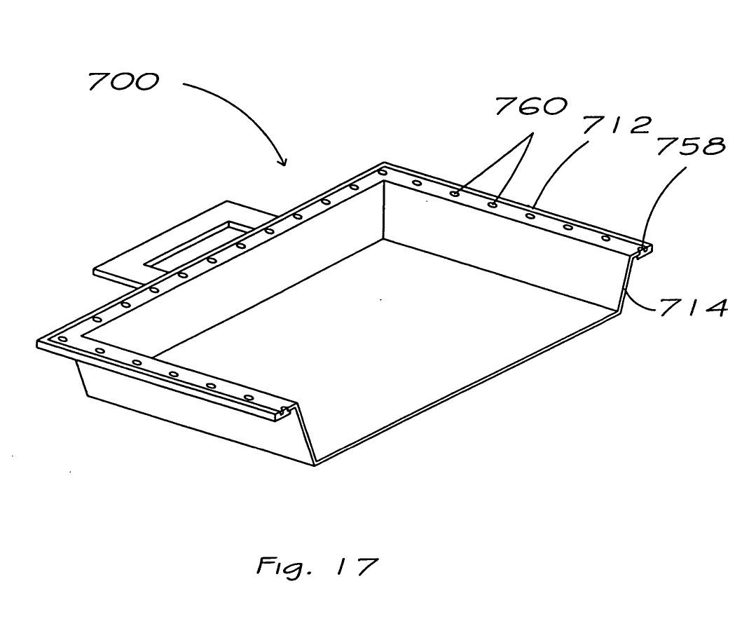

The cookware 600, 700 in the illustrated embodiments of FIGS. 16 and 17 are similar in construction to the cookware 500 described above in connection with FIGS. 8-15, and are presented to demonstrate that the frame 612, 712 and body 614, 714 can have different shapes while still falling within the spirit and scope of the present invention. For example, the frame 612 illustrated in FIG. 16 has a substantially flat cross-sectional shape (as opposed to the lobed outer periphery of the cross sectional shape of the frame 512 illustrated in FIGS. 8-11, 13, and 14). Still other frame shapes can be utilized as desired. Also, the bodies 614, 714 illustrated in FIGS. 16 and 17 are in the shape of a cake pan, rather than the muffin pan in the illustrated embodiment of FIGS. 8-15. As mentioned above, the cookware can take any other shape desired.

The cookware 700 illustrated in FIG. 17 is also an example of the different manners in which the body 714 can be positioned with respect to the frame 712. As described above in connection with the cookware 500 illustrated in FIGS. 8-15, the body 714 can cover any portion or all of the frame 712. For example, the body 714 illustrated in FIG. 17 covers only the inner edge 756 and a portion of the top 758 of the frame 712, leaving exposed the remainder of the frame 712. The body 714 can instead cover any other portion of the frame 712 in other embodiments. Also, columns 760 connecting the body 714 of the cookware 700 to the frame 712 are defined by the frame 712 rather than the body 714, and still provide a secure mechanical connection between these elements.

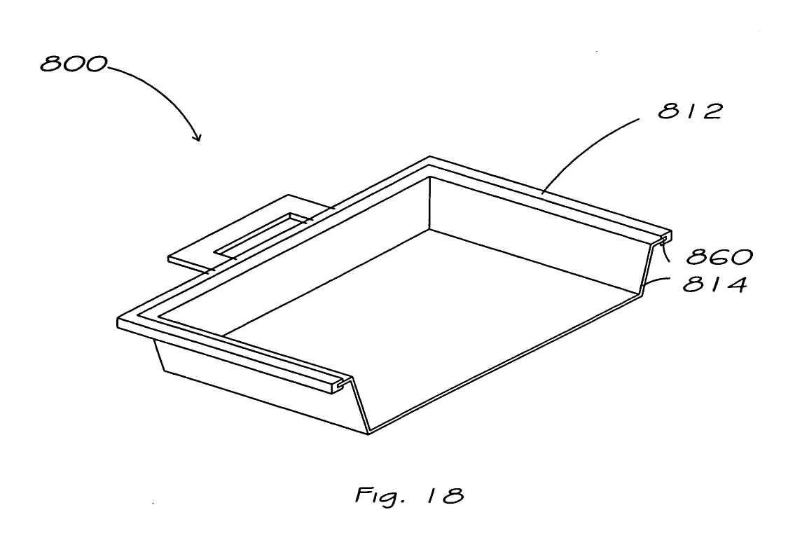

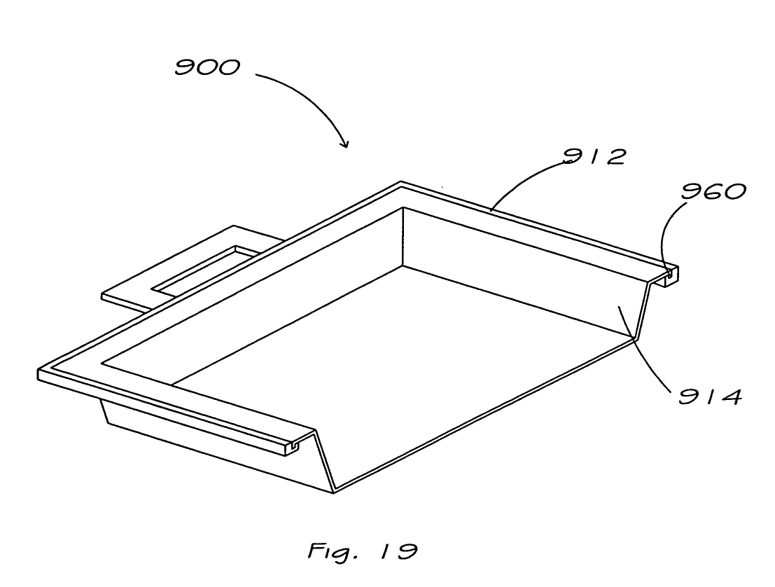

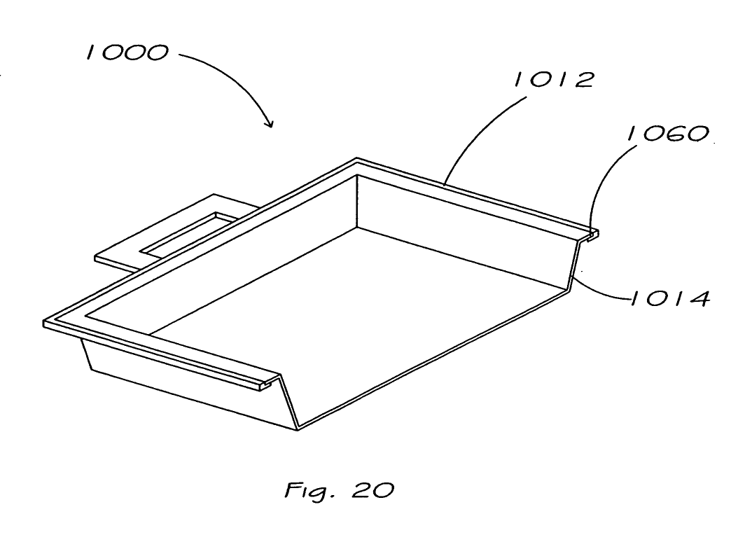

The cookware 800, 900, 1000 illustrated in FIGS. 18-20 are additional examples of possible relationships between the body 814, 914, 1014 and the frame 812, 912, 1012. In each case, the frame 812, 912, 1012 is provided with an aperture 860, 960, 1060 (e.g., a recess, groove, or other void) in which the body 814, 914, 1014 is received. The aperture 860, 960, 1060 can be interrupted or uninterrupted, and can be elongated as shown in FIGS. 18-20, and can open in any direction, such as laterally (see FIG. 18), upwardly (see FIG. 19), laterally and upwardly (see FIG. 20), downwardly, or in any other direction or combination of directions desired for receiving the body 814, 914, 1014. In such embodiments, the connection between the frame 812, 912, 1012 and the body 814, 914, 1014 can be substantially mechanical in nature, can rely upon a chemical bond between the silicone elastomer material of the body 814, 914, 1014 and surfaces of the frame 812, 912, 1012, or can be both mechanical and chemical.

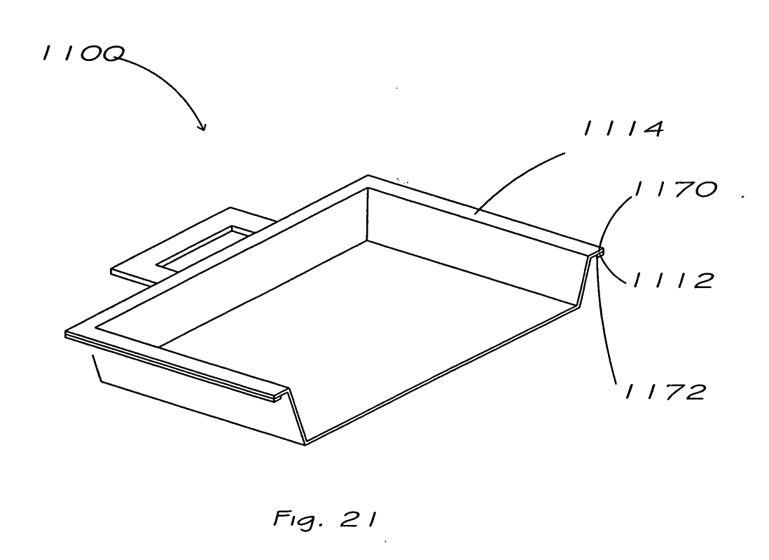

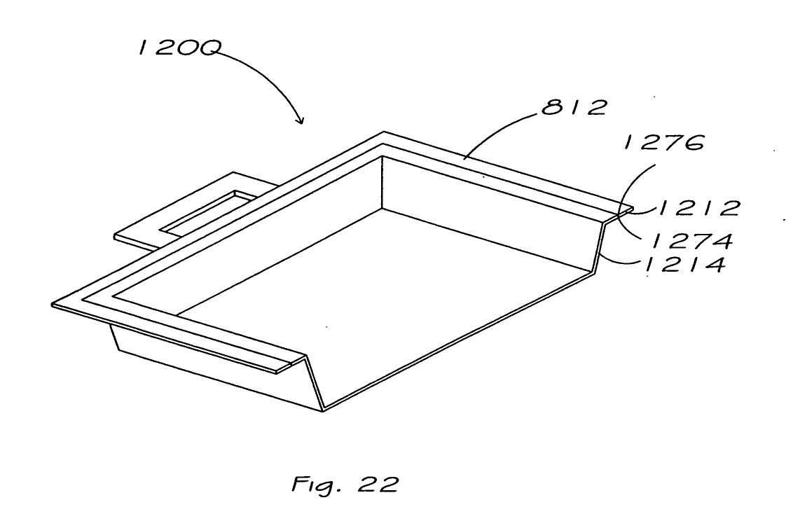

The cookware 1100, 1200 illustrated in FIGS. 21 and 22 are still additional examples of possible relationships between the body 1114, 1214 and the frame 1112, 1212. In both embodiments, the frame 1112, 1212 is in contact with the body 1114, 1214 along a substantially planar interface, wherein no aperture exists in the frame 1112, 1212 or the body 1114, 1214 in which the body 1114, 1214 or frame 1112, 1212 is received, respectively. Such a relationship between the frame 1112, 1212 and body 1114, 1214 can be defined regardless of what surface of the frame 1112, 1212 (e.g., top, bottom, or side) is contacted by the body 1114, 1214. For example, a top surface 1170 of the frame 1112 is connected to a bottom surface 1172 of the body 1114 in the illustrated embodiment of FIG. 21, whereas a laterally-facing side surface 1274 of the frame 1212 is connected to a laterally-facing side surface 1276 of the body 1214 in the illustrated embodiment of FIG. 22. Although a mechanical connection between the frame 1112, 1212 and body 1114, 1214 is still possible in such embodiments, the frame 1112, 1212 and body 1114, 1214 can be connected to one another in such embodiments primarily (and in some cases, exclusively) by a chemical bond between the frame 1112, 1212 and the body 1114, 1214.

As mentioned above, the cookware according to the various embodiments of the present invention can be manufactured in a number of different manners. In some embodiments, and by way of example only, the frame 12, 112, . . . 1212 may be formed in one or more operations prior to producing the cookware as a single unit. For example, a plastic frame 12, 112, . . . 1212 can be molded into a desired shape. Then, the frame 12, 112, . . . 1212 can be inserted into a body mold where liquid silicone elastomer material is poured, injected, or otherwise introduced at least partially around the frame 12, 112, . . . 1212. In some embodiments (e.g., for high-temperature cured silicone elastomers), the body 14, 114, . . . 1214 can be molded using transfer molding techniques. If the frame 12, 112, 1212 and silicone elastomer body 14, 114, . . . 1214 are to be releasably connected, they can be independently formed and then joined during a subsequent assembly process or by the end user.

In any of the embodiments described herein, the substantially rigid frame 12, 112, . . . 1212 can be inserted into a mold cavity as just described to provide a surface upon which the silicone elastomer material will adhere. The resulting connection between the frame 12, 112, . . . 1212 can be mechanical and/or chemical in nature. The ability to use plastic rigid frames 12, 112, . . . 1212 overmolded with silicone elastomer material can also allow manufacturers to provide the frame 12, 112, . . . 1212 and/or the body 14, 114, . . . 1214 with any color, such as by adding FDA-compliant pigments to the material of either part during the manufacture of that part.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. Cookware for holding food product, comprising:
a body comprising flexible silicone elastomer, the body shaped to define at least one receptacle adapted to hold food product, wherein at least a portion of the body is deformable at least partially due to flexibility of the silicone elastomer; and
a frame coupled to the body, the frame having at least one aperture into which is received a portion of the silicone elastomer.

2. The cookware as claimed in claim 1, wherein the flexible silicone elastomer is cross-linked with platinum.

3. The cookware as claimed in claim 1, wherein the flexible silicone elastomer is cross-linked with peroxide.

4. The cookware as claimed in claim 1, wherein the flexible silicone elastomer is sufficiently stiff to prevent folding of the body.

5. The cookware as claimed in claim 1, wherein the at least one aperture comprises a substantially elongated groove into which the portion of the silicone elastomer is received.

6. The cookware as claimed in claim 1, wherein the frame is overmolded with the flexible silicone elastomer.

7. The cookware as claimed in claim 1, wherein the frame is substantially surrounded by the body.

8. The cookware as claimed in claim 1, wherein the flexible silicone elastomer is chemically bonded to the frame.

9. The cookware as claimed in claim 1, wherein the frame and the body are in contact with one another in a substantially planar interface.

10. Cookware for holding food product, comprising:
a body comprising flexible silicone elastomer, the body shaped to define at least one receptacle adapted to hold food product, wherein at least a portion of the body is deformable at least partially due to flexibility of the silicone elastomer; and
a frame coupled to the body by a bond between a surface of the frame and the flexible silicone elastomer.

11. The cookware as claimed in claim 10, wherein the flexible silicone elastomer is chemically bonded to the frame.

12. The cookware as claimed in claim 10, wherein the flexible silicone elastomer is cross-linked with platinum.

13. The cookware as claimed in claim 10, wherein the flexible silicone elastomer is cross-linked with peroxide.

14. The cookware as claimed in claim 10, wherein the flexible silicone elastomer is sufficiently stiff to prevent folding of the body.

15. The cookware as claimed in claim 10, wherein:
the body has a periphery; and
the frame extends about the body along the periphery of the body.

16. The cookware as claimed in claim 10, wherein the frame is overmolded with the flexible silicone elastomer.

17. The cookware as claimed in claim 10, wherein the frame is substantially surrounded by the body.

18. The cookware as claimed in claim 10, wherein the frame and the body are in contact with one another in a substantially planar interface.

19. A method of manufacturing cookware, comprising:
providing a substantially rigid frame;
bonding liquid silicone elastomer material to the frame;
forming a body of flexible silicone elastomer having at least one receptacle shaped and dimensioned to removably receive food product; and
coupling the body to the frame by bonding the liquid silicone elastomer to the frame.

20. The method as claimed in claim 19, wherein coupling the body to the frame comprises overmolding the frame with the liquid silicone elastomer.

21. The method as claimed in claim 19, wherein the frame has a cross-sectional shape at least partially defining an aperture, the method further comprising inserting liquid silicone elastomer within the aperture in the frame.

22. The method as claimed in claim 19, wherein the flexible silicone elastomer is cross-linked with platinum, the method further comprising curing the body of flexible silicone elastomer.

23. The method as claimed in claim 19, wherein the flexible silicone elastomer is cross-linked with peroxide, the method further comprising curing the body of flexible silicone elastomer.
